(19) United States
(12) Patent Application Publication
(10) Pub. No.: US 2015/0100383 A1
(43) Pub. Date: Apr. 9, 2015

(54) METHOD AND SYSTEM TO MEASURE CUSTOMER TRAFFIC AT A MERCHANT LOCATION

(71) Applicant: MasterCard International Incorporated, Purchase, NY (US)

(72) Inventor: Rohit CHAUHAN, Somers, NY (US)

(73) Assignee: MasterCard International Incorporated, Purchase, NY (US)

(21) Appl. No.: 14/048,774

(22) Filed: Oct. 8, 2013

(51) Int. Cl. G06Q 30/02

(52) U.S. Cl. CPC G06Q 30/0205
USPC 705/7.34

(57) ABSTRACT

A method for measuring consumer traffic at a merchant location includes: storing, in a database, a consumer profile, wherein the consumer profile includes data related to a consumer including at least a device identifier corresponding to a mobile communication device associated with the related consumer; receiving, by a receiving device, a plurality of location data entries, wherein each location data entry includes at least a time and/or date at which the associated mobile communication device is identified as being located at a specific geographic location associated with a merchant; calculating, by a processing device, at least one traffic metric for the consumer and the specific geographic location based on the time and/or date included in each of the received plurality of location data entries; and associating, in the database, the consumer profile with the received plurality of location data entries and the calculated at least one traffic metric.

### FIELD

The present disclosure relates to measuring consumer traffic at a merchant location, specifically the use of geographic location information of consumer mobile devices at a merchant location to calculate a plurality of traffic metrics measuring consumer traffic at the merchant location.

### BACKGROUND

Merchants can find a lot of value in data regarding consumer traffic at a physical storefront location. This data may help merchants select advertising, storefront decorations and displays, merchandise, offered services, and much more. It is of interest to these merchants to obtain data regarding consumer traffic that is as accurate as possible. In an effort to capture this data, methods and systems have been designed to measure consumer traffic in an out of a store.

For example, some merchants use an employee or an electronic system to count the number of people that enter and/or exit a store. However, while these systems can track overall traffic generally, they are often unable to distinguish one consumer from another, which prohibits the merchant from obtaining any detailed data regarding overall consumer traffic, or any data regarding the movement of a specific consumer in or out of the merchant's location. Other systems that may be used include those where consumers may connect to a local network provided by the merchant. However, such a system requires a number of actions to be performed by the consumer, which can be a deterrent to consumers and result in inaccurate measurements.

Thus, there is a need for a technical solution to more accurately and efficiently measure consumer traffic at a merchant location.

### SUMMARY

The present disclosure provides a description of systems and methods for measuring consumer traffic at a merchant location.

A method for measuring consumer traffic at a merchant location includes: storing, in a database, a consumer profile, wherein the consumer profile includes data related to a consumer including at least a device identifier corresponding to a mobile communication device associated with the related consumer; receiving, by a receiving device, a plurality of location data entries, wherein each location data entry includes at least a time and/or date at which the associated mobile communication device is identified as being located at a specific geographic location associated with a merchant; calculating, by a processing device, at least one traffic metric for the consumer and the specific geographic location based on the time and/or date included in each of the received plurality of location data entries; and associating, in a database, the consumer profile with the received plurality of location data entries and the calculated at least one traffic metric.

Another method for measuring consumer traffic at a merchant location includes: storing, in a database, a plurality of consumer profiles, wherein each consumer profile includes data related to a consumer including at least a device identifier corresponding to a mobile communication device associated with the related consumer; receiving, by a receiving device, a plurality of location data entries, wherein each location data entry includes at least a device identifier and a time and/or date at which a mobile communication device associated with the included device identifier is identified as being located at a specific geographic location associated with a merchant; associating, in the database, each the received plurality of location data entries with a corresponding consumer profile based on the included device identifiers; calculating, by a processing device, at least one traffic metric for consumer traffic at the specific geographic location based on the time and/or date included in each of the plurality of location data entries associated with each consumer profile stored in the database; and associating, by the processing device, the calculated at least one traffic metric with the merchant.

A system for measuring consumer traffic at a merchant location includes a database, a receiving device, and a processing device. The database is configured to store a consumer profile, wherein the consumer profile includes data related to a consumer including at least a device identifier corresponding to a mobile communication device associated with the related consumer. The receiving device is configured to receive a plurality of location data entries, wherein each location data entry includes at least a time and/or date at which the associated mobile communication device is identified as being located at a specific geographic location associated with a merchant. The processing device is configured to: calculate at least one traffic metric for the consumer and the specific geographic location based on the time and/or date included in each of the received plurality of location data entries; and associate, in a database, the consumer profile with the received plurality of location data entries and the calculated at least one traffic metric.

Another system for measuring consumer traffic at a merchant location includes a database, a receiving device, and a processing device. The database is configured to store a plurality of consumer profiles, wherein each consumer profile includes data related to a consumer including at least a device identifier corresponding to a mobile communication device associated with the related consumer. The receiving device is configured to receive a plurality of location data entries, wherein each location data entry includes at least a device identifier and a time and/or date at which a mobile communication device associated with the included device identifier is identified as being located at a specific geographic location associated with a merchant. The processing device is configured to: associate, in the database, each the received plurality of location data entries with a corresponding consumer profile based on the included device identifiers; calculate at least one traffic metric for consumer traffic at the specific geographic location based on the time and/or date included in each of the plurality of location data entries associated with each consumer profile stored in the database; and associate the calculated at least one traffic metric with the merchant.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for measuring consumer traffic at a merchant location in accordance with exemplary embodiments.

FIG. 2 is a block diagram illustrating the processing server of FIG. 1 for the measuring of consumer traffic in accordance with exemplary embodiments.

FIG. 3 is diagram illustrating identified consumer traffic at a merchant location and the calculation of traffic metrics based thereon in accordance with exemplary embodiments.

FIGS. 4 and 5 are flow charts illustrating exemplary methods for measuring consumer traffic at a merchant location in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definitions

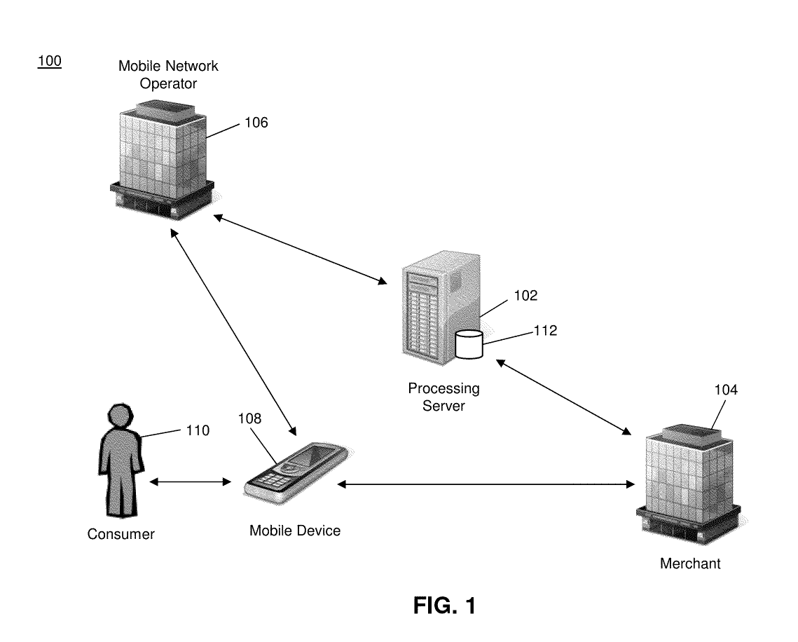

Personally identifiable information (PII)-PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 102 (shown in FIG. 1) does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers, and thus, no longer be personally identifiable to that consumer. In other embodiments, encryption may be used. For example, personally identifiable information (e.g., an account number) may be encrypted (e.g., using a one-way encryption) such that the processing server 102 may not possess the PII or be able to decrypt the encrypted PII.

### System for Measuring Consumer Traffic at a Merchant Location

FIG. 1 illustrates a system 100 for measuring consumer traffic at a merchant location based on geographic location data of consumer mobile devices.

The system 100 may include a processing server 102. The processing server 102, discussed in more detail below, may be configured to measure consumer traffic at a merchant 104 using systems and methods as discussed herein. The merchant 104 may operate a store having a physical location and may have a desire to receive metrics regarding consumer traffic at the physical location.

In order to measure the consumer traffic, the processing server 102 may request geographic location data from a mobile network operator 106. The mobile network operator 106 may be the operator of a mobile communication network (e.g., a cellular network) that services a plurality of mobile communication devices, such as a mobile device 108. The mobile device 108 may be any type of mobile communication device suitable for performing the functions as disclosed herein, such as a cellular phone, smart phone, tablet computer, laptop computer, etc.

The mobile network operator 106 may be configured to identify the geographic location of the mobile device 108. The geographic location of the mobile device 108 may be identified via the global positioning system, cellular network triangulation, connection by the mobile device 108 to a wireless network, reading of a machine-readable code displayed at a specific geographic location, receiving of an aural signal emitted at the specific geographic location, and other suitable methods that will be apparent to persons having skill in the relevant art. The mobile network operator 106 may identify the geographic location of the mobile device 108 at predetermined periods of time, such as every five minutes, every fifteen minutes, every half hour, every hour, after a significant change in the physical location of the mobile device 108, when prompted by the mobile device 108, etc.

The mobile device 108 may be associated with a consumer 110. The consumer 110 may take the mobile device 108 and visit the merchant 104. The mobile network operator 106 may identify the geographic location of the mobile device 108 to identify that the consumer 110 has visited the merchant 104 based on the geographic location. The mobile network operator 106 may continue to identify the geographic location of the mobile device 108 and, when appropriate, identify when the consumer 110 has left the merchant 104 based on the mobile device 108. The mobile network operator 106 may store the geographic location data as a plurality of location data entries.

The mobile network operator 106 may transmit the plurality of location data entries regarding consumer mobile devices 108 being located at the physical location of the merchant 104 to the processing server 102. In some embodiments, the processing server 102 may receive location data entries from a plurality of mobile network operators 106. In some instances, the mobile network operator 106 may transmit location data entries to the processing server 102 in real-time. In other instances, the mobile network operator 106 may transmit location data entries to the processing server 102 in batches (e.g., at predetermined periods of time, for specific locations, for specific consumers, at the request of the processing server 102, etc.). The processing server 102 may store the received location data entries in a location database, discussed in more detail below. The processing server 102 may then identify traffic metrics based on the location data entries, as discussed in more detail below, for the merchant 104.

In some embodiments, the processing server 102 may also include a consumer database 112. The consumer database 112, discussed in more detail below, may include a plurality of consumer profiles, each associated with a consumer 110. The processing server 102 may store location data entries associated with a particular consumer 110 (e.g., based on an associated mobile device 108) in the corresponding consumer profile. The processing server 102 may then identify traffic metrics for each consumer 110 based on the location data entries in the corresponding consumer profile. In an exemplary embodiment, the consumer profile may not include any personally identifiable information. For example, the consumer profile may be based on an identifier of the mobile device 108, such as a media access control (MAC) address, etc.

In some embodiments, each consumer profile may also include demographic characteristics associated with the corresponding consumer 110. The demographic characteristics may include age, gender, income, residential status, marital status, geographic location, familial status, education, occupation, etc. In an exemplary embodiment, the demographic characteristics may not be personally identifiable. In such a situation, the demographics may be used to calculate more specific traffic metrics, such as with regard to specific demographics.

The use of the systems and methods discussed herein for measuring consumer traffic can provide a more accurate assessment of consumer traffic as well as more detailed data regarding the consumer traffic. For example, the processing server 102 may be able to identify the average length of time a consumer 110 visits the merchant 104, how often particular consumers visit the merchant 104, if a consumer 110 is visiting the merchant 104 for the first time or is a repeat visitor, number of unique visitors to the merchant 104 in a given period of time, etc. By using mobile devices 108, the processing server 102 may be able to identify unique consumers 110 visiting the merchant 104, which can provide a wealth of data to the merchant 104, and may be even more valuable when combined with additional data regarding the consumers 110, which may be entirely unavailable using traditional systems and methods for measuring consumer traffic.

Processing Device

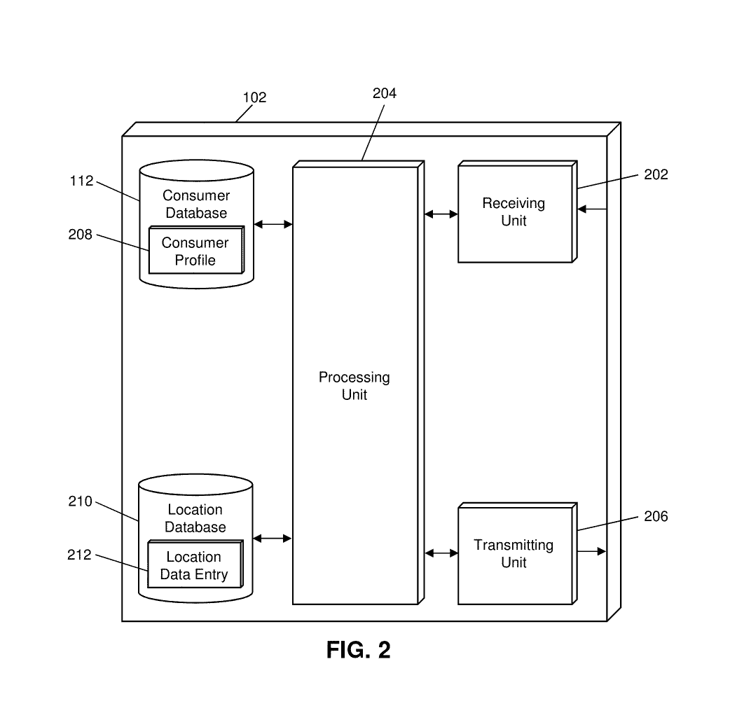

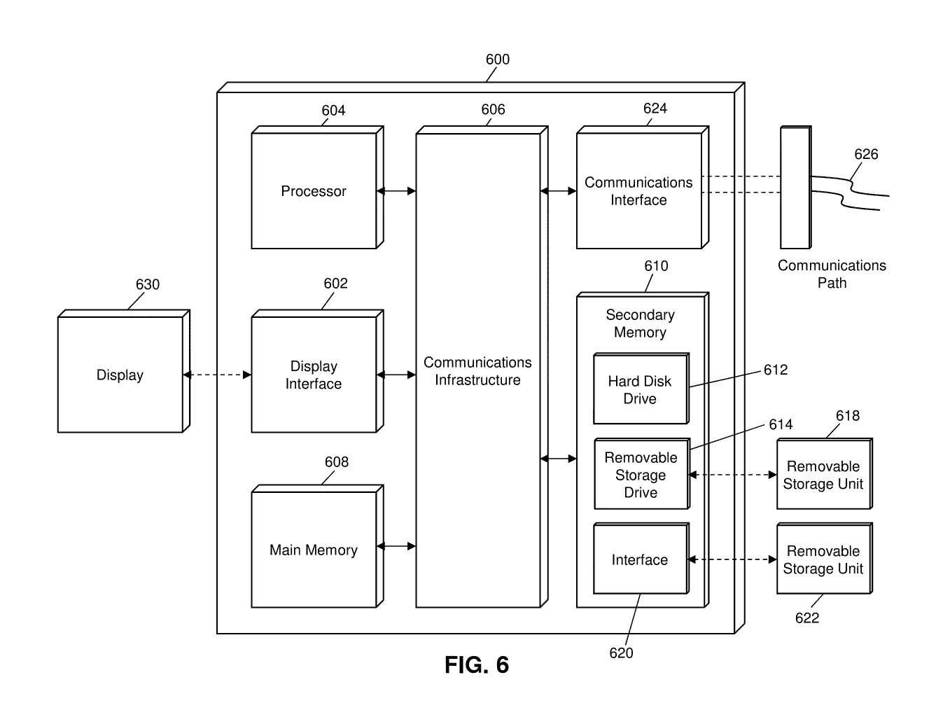

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive the location data entries transmitted to the processing server 102 by the mobile network operator 106. In some embodiments, the receiving unit 202 may be further configured to receive a request for consumer traffic metrics from the merchant 104 or a third party (e.g., an advertiser) and/or demographic characteristics or other data from one or more third parties.

The processing server 102 may also include a processing unit 204. The processing unit 204 may be configured to generate a plurality of consumer profiles 208 to store in the consumer database 112. Each consumer profile 208 may include data related to a consumer 110 including at least a device identifier corresponding to a mobile device 108 associated with the consumer 110. The device identifier may be a unique value associated with the mobile device 108, such as a MAC address, phone number, or other suitable value that will be apparent to persons having skill in the relevant art. The processing unit 204 may also store received consumer data, such as demographic characteristics, in the corresponding consumer profile 208. In an exemplary embodiment, each consumer profile 208 may not include any personally identifiable information.

The processing server 102 may also include a location database 210. The location database 210 may include a plurality of location data entries 212. Each location data entry 212 may include data related to a geographic location of a mobile device 108 including at least the device identifier for the related mobile device 108 and the geographic location. The geographic location may be represented by latitude and longitude, a street address, zip or postal code, merchant name, a location identifier, or any other suitable representation that will be apparent to persons having skill in the relevant art. In some embodiments, each location data entry 212 may also include a length of time the mobile device 108 remained at the corresponding geographic location and/or an indication of the mobile device 108 as entering or leaving the corresponding geographic location (e.g., based on previous or following identified geographic locations of the related mobile device 108).

The processing unit 204 may be further configured to identify traffic metrics for one or more consumers and/or one or more merchants based on geographic location data. In instances where traffic metrics may be identified for a consumer 110, the processing unit 204 may calculate the metrics based on location data entries 212 included in the corresponding consumer profile 208 and/or location data entries 212 included in the location database 210 and including a device identifier associated with a mobile device 108 associated with the consumer 110. In instances when traffic metrics may be identified for a merchant 104, the processing unit 204 may calculate the metrics based on all location data entries 212, including a geographic location associated with the merchant 104. The calculation of traffic metrics based on location data is discussed in more detail below.

The processing server 102 may also include a transmitting unit 206. The transmitting unit 206 may be configured to transmit data over one or more networks via one or more network protocols. The transmitting unit 206 may be configured to transmit calculated traffic metrics to a third party (e.g., the merchant 104) in response to a previously received request for traffic metrics.

### Calculating Traffic Metrics

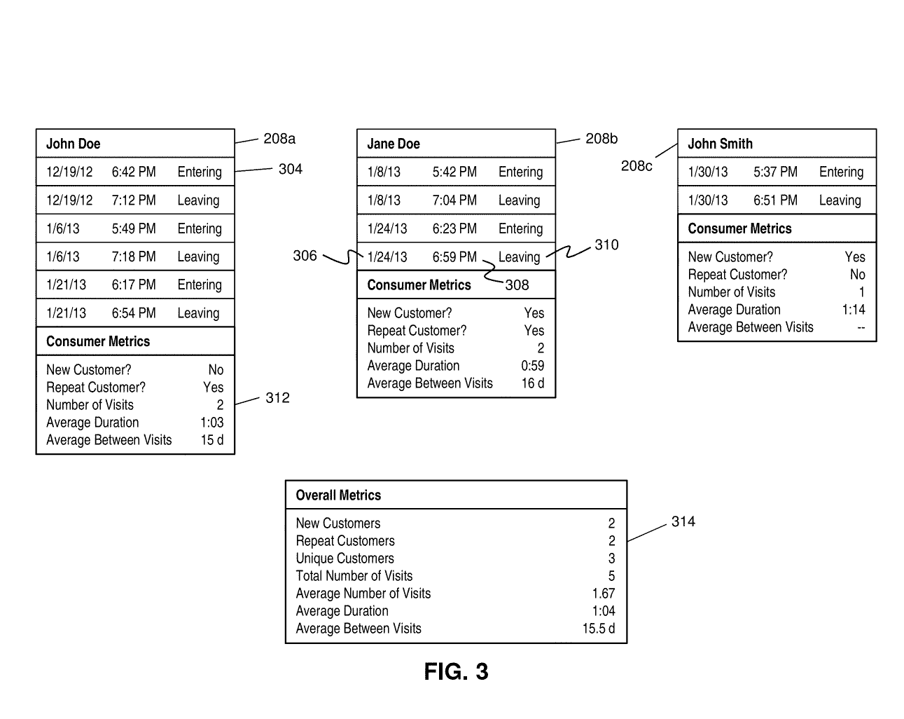

FIG. 3 illustrates the calculation of traffic metrics based on consumer geographic location data at the merchant 104.

As illustrated in FIG. 3, the consumer database 112 of the processing server 102 may include a plurality of consumer profiles 208, illustrated as consumer profiles 208a, 208b, and 208c. Each consumer profile 208 is associated with a consumer 110. It will be apparent to persons having skill in the relevant art that the example illustrated in FIG. 3 is provided as an illustration only, and that in exemplary embodiments, no personally identifiable information may be included in each consumer profile 208.

Each consumer profile 208 may include a plurality of location data entries 304. Each location data entry 304 may be similar (e.g., or the same) to the location data entries 212 included in the location database 210, but as identified as being associated with the specific associated consumer 110 related to the respective consumer profile 208. Each location data entry 304 may correspond to a time at which a mobile device 108 associated with the corresponding consumer 110 was identified at a geographic location corresponding to the merchant 104. To this end, each location data entry 304 may include at least a time 308 and date 306 at which the mobile device 108 was identified at the geographic location, and an indication 310 of the mobile device 108 entering or leaving the geographic location of the merchant 104.

The processing unit 204 may calculate a plurality of consumer traffic metrics 312 based on the transaction data entries 304 for the corresponding consumer. As illustrated in FIG. 3, the processing unit 204 may identify if the consumer is a new customer and/or a repeat customer, the total number of visits at the merchant 104, the average duration of each visit at the merchant 104, and the average length of time between visits.

In the example illustrated in FIG. 3, John Doe, who is associated with the consumer profile 208a, visited the merchant 104 on Dec. 19, 2012, Jan. 6, 2013, and Jan. 21, 2013. The processing server 102 may be instructed (e.g., by request from the merchant 104 or a third party) to identify consumer metrics for each consumer 110 for the month of January. As illustrated in FIG. 3, the processing unit 204 may calculate the metrics for John Doe to indicate that John Doe is not a new customer, as he visited the merchant 104 prior to January, he is a repeat customer, he has visited the merchant 104 twice, visits the merchant for one hour and three minutes on average, and averages fifteen days between visits to the merchant 104. The systems and methods herein may be advantageous as such information may be unable to identify using traditional systems and methods for measuring consumer traffic.

The processing server 102 may similarly calculate consumer metrics for the remaining two consumer profiles 208b and 208c. The processing server 102 may also be requested or may also desire to calculate overall traffic metrics for all consumers (e.g., the consumers related to the consumer profiles 208a, 208b, and 208c) visiting the merchant 104 during January. In such an instance, the processing unit 204 of the processing server 102 may calculate overall traffic metrics 314.

The overall traffic metrics 314 may include similar metrics as calculated for each individual consumer, but may also include additional metrics, such as the total number of unique customers or the overall total number of customer visits. Additional consumer traffic metrics 312 and/or overall traffic metrics 314 will be apparent to persons having skill in the relevant art. In embodiments where the processing server 102 may receive a request for consumer traffic metrics 312 and/or overall traffic metrics 314, the transmitting unit 206 may transmit the calculated traffic metrics 312 and/or 314 to the requester in response to the received request.

### First Exemplary Method for Measuring Consumer Traffic

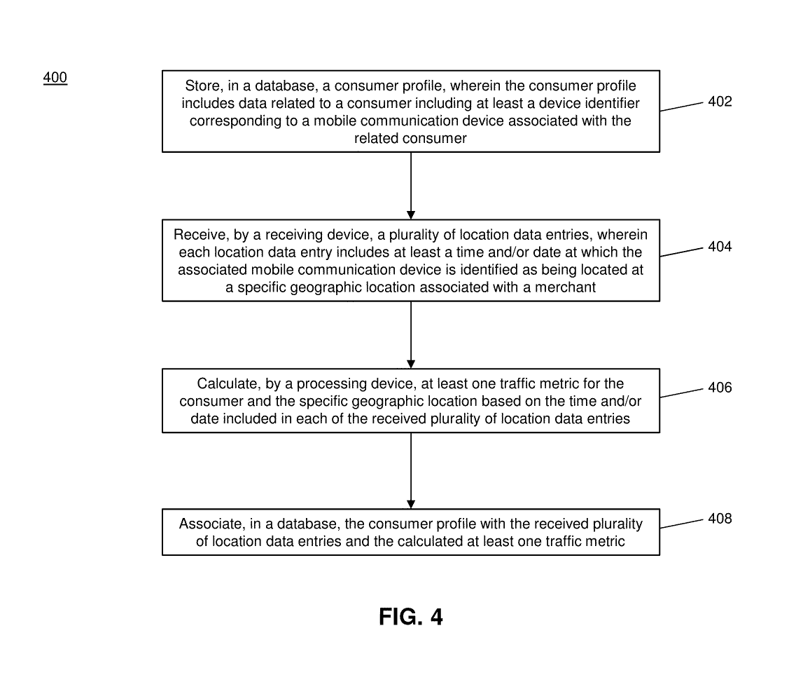

FIG. 4 illustrates a method 400 for the measuring of consumer traffic based on geographic location data of a consumer 110.

In step 402, a consumer profile (e.g., the consumer profile 208), may be stored, in a database (e.g., the consumer database 112), wherein the consumer profile 208 includes data related to a consumer (e.g., the consumer 110) including at least a device identifier corresponding to a mobile communication device (e.g., the mobile device 108) associated with the related consumer 110.

In step 404, a plurality of location data entries (e.g., the location data entries 304) may be received, by a receiving device (e.g., the receiving unit 202), wherein each location data entry 304 may include at least a time (e.g., the time 308) and/or date (e.g., the date 306) at which the associated mobile communication device 108 is identified as being located at a specific geographic location associated with a merchant (e.g., the merchant 104). In one embodiment, each location data entry 304 may further include an indication (e.g., the indication 310) of the mobile communication device 108 as entering, remaining at, or leaving the specific geographic location. In some embodiments, the mobile communication device 108 may be identified as being located at the specific geographic location using at least one of: global positioning system, cellular network triangulation, connection to a wireless network, reading of a machine-readable code located at the specific geographic location, and receiving of an aural signal emitted at the specific geographic location.

In step 406, at least one traffic metric (e.g., the consumer traffic metrics 312) may be calculated, by a processing device (e.g., the processing unit 204), for the consumer 110 and the specific geographic location based on the time 308 and/or date 306 included in each of the received plurality of location data entries 304. In some embodiments, the at least one traffic metric 312 may include at least one of: number of visits, average duration of visit, and average duration between visits. In step 408, the consumer profile 208 may be associated, in a database (e.g., the consumer database 112), with the received plurality of location data entries 304 and the calculated at least one traffic metric 312.

In one embodiment, the method 400 may further comprise: receiving, by the receiving device 202, a request for traffic metrics, wherein the request for traffic metrics includes an identifier associated with the consumer 110 and the at least one traffic metric 312; and transmitting, by a transmitting device (e.g., the transmitting unit 206), the calculated at least one traffic metric 312 in response to the received request for traffic metrics. In a further embodiment, the request for traffic metrics may further include a predefined period of time, and wherein the time 308 and/or date 306 included in each of the plurality of location data entries 304 is included within the predefined period of time.

### Second Exemplary Method for Measuring Consumer Traffic

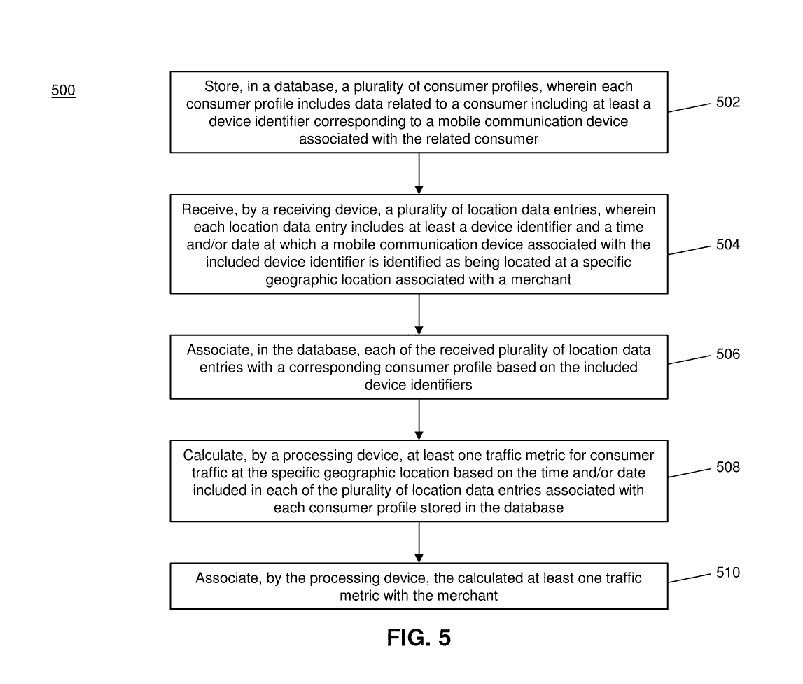

FIG. 5 illustrates an alternative method 500 for the measuring of consumer traffic based on geographic location data of a consumer 110.

In step 502, a plurality of consumer profiles (e.g., the consumer profiles 208) may be stored in a database (e.g., the consumer database 112), wherein each consumer profile 208 includes data related to a consumer (e.g., the consumer 110) including at least a device identifier corresponding to a mobile communication device (e.g., the mobile device 108) associated with the related consumer 110.

In step 504, a plurality of location data entries (e.g., the location data entries 304) may be received, by a receiving device (e.g., the receiving unit 202), wherein each location data entry 304 may include at least a device identifier and a time (e.g., the time 308) and/or date (e.g., the date 306) at which a mobile communication device 108 associated with the included device identifier is identified as being located at a specific geographic location associated with a merchant (e.g., the merchant 104). In one embodiment, each location data entry 304 may further include an indication (e.g., the indication 310) of the associated mobile communication device 108 as entering, remaining at, or leaving the specific geographic location. In some embodiments, the mobile communication device 108 may be identified as being located at the specific geographic location using at least one of: global positioning system, cellular network triangulation, connection to a wireless network, reading of a machine-readable code located at the specific geographic location, and receiving of an aural signal emitted at the specific geographic location.

In step 506, each of the received plurality of location data entries 304 may be associated, in a database (e.g., the consumer database 112), with a corresponding consumer profile 208 based on the included device identifiers. In step 508, at least one traffic metric (e.g., the overall traffic metrics 314) may be calculated, by a processing device (e.g., the processing unit 204), for consumer traffic at the specific geographic location based on the time 308 and/or date 306 included in each of the plurality of location data entries 304 associated with each consumer profile 208 stored in the database 112. In one embodiment, the at least one traffic metric 314 may include at least one of: number of new consumers, number of repeat consumers, total number of consumer visits, average number of consumer visits, number of unique consumers, average duration of consumer visits, and average duration between consumer visits.

In step 510, the processing device 204 may associated the calculated at least one traffic metric 314 with the merchant 104. In one embodiment, the method 500 may further include: receiving, by the receiving device 202, a request for traffic metrics, wherein the request for traffic metrics includes the at least one traffic metric 314 that is being requested and one of: the specific geographic location or the merchant 104; and transmitting, by a transmitting device (e.g., the transmitting unit 206), the calculated at least one traffic metric 314 in response to the received request for traffic metrics. In a further embodiment, the request for traffic metrics may further include a predefined period of time, wherein the time 308 and/or date 306 included in each of the plurality of location data entries 304 is included within the predefined period of time.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 604 may be a special purpose or a general purpose processor device. The processor 604 may be connected to a communication infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for measuring consumer traffic at a merchant location. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for measuring consumer traffic at a merchant location, comprising:
storing, in a database, a consumer profile, wherein the consumer profile includes data related to a consumer including at least a device identifier corresponding to a mobile communication device associated with the related consumer;
receiving, by a receiving device, a plurality of location data entries, wherein each location data entry includes at least a time and/or date at which the associated mobile communication device is identified as being located at a specific geographic location associated with a merchant;
calculating, by a processing device, at least one traffic metric for the consumer and the specific geographic location based on the time and/or date included in each of the received plurality of location data entries; and
associating, in a database, the consumer profile with the received plurality of location data entries and the calculated at least one traffic metric.

2. The method of claim 1, further comprising:
receiving, by the receiving device, a request for traffic metrics, wherein the request for traffic metrics includes an identifier associated with the consumer and the at least one traffic metric, and
transmitting, by a transmitting device, the calculated at least one traffic metric in response to the received request for traffic metrics.

3. The method of claim 2, wherein the request for traffic metrics further includes a predefined period of time, and wherein the time and/or date included in each of the plurality of location data entries is included within the predefined period of time.

4. The method of claim 1, wherein the at least one traffic metric includes at least one of: number of visits, average duration of visit, and average duration between visits.

5. The method of claim 1, wherein each location data entry further includes an indication of the mobile communication device as entering, remaining at, or leaving the specific geographic location.

6. The method of claim 1, wherein the associated mobile communication device is identified as being located at the specific geographic location using at least one of: global positioning system, cellular network triangulation, connection to a wireless network, reading of a machine-readable code located at the specific geographic location, and receiving of an aural signal emitted at the specific geographic location.

7. A method for measuring consumer traffic at a merchant location, comprising:
storing, in a database, a plurality of consumer profiles, wherein each consumer profile includes data related to a consumer including at least a device identifier corresponding to a mobile communication device associated with the related consumer;
receiving, by a receiving device, a plurality of location data entries, wherein each location data entry includes at least a device identifier and a time and/or date at which a mobile communication device associated with the included device identifier is identified as being located at a specific geographic location associated with a merchant;
associating, in the database, each the received plurality of location data entries with a corresponding consumer profile based on the included device identifiers;
calculating, by a processing device, at least one traffic metric for consumer traffic at the specific geographic location based on the time and/or date included in each of the plurality of location data entries associated with each consumer profile stored in the database; and
associating, by the processing device, the calculated at least one traffic metric with the merchant.

8. The method of claim 7, further comprising:
receiving, by the receiving device, a request for traffic metrics, wherein the request for traffic metrics includes the at least one traffic metric and one of: the specific geographic location and the merchant; and
transmitting, by a transmitting device, the calculated at least one traffic metric in response to the received request for traffic metrics.

9. The method of claim 8, wherein the request for traffic metrics further includes a predefined period of time, and wherein the time and/or date included in each of the plurality of location data entries is included within the predefined period of time.

10. The method of claim 7, wherein the at least one traffic metric includes at least one of: number of new consumers, number of repeat consumers, total number of consumer visits, average number of consumer visits, number of unique consumers, average duration of consumer visits, and average duration between consumer visits.

11. The method of claim 7, wherein each location data entry further includes an indication of the associated mobile communication device as entering, remaining at, or leaving the specific geographic location.

12. The method of claim 7, wherein the respective mobile communication device associated with the device identifier included in each of the plurality of transaction data entries is identified as being located at the specific geographic location using at least one of: global positioning system, cellular network triangulation, connection to a wireless network, reading of a machine-readable code located at the specific geographic location, and receiving of an aural signal emitted at the specific geographic location.

13. A system for measuring consumer traffic at a merchant location, comprising:
a database configured to store a consumer profile, wherein the consumer profile includes data related to a consumer including at least a device identifier corresponding to a mobile communication device associated with the related consumer;
a receiving device configured to receive a plurality of location data entries, wherein each location data entry includes at least a time and/or date at which the associated mobile communication device is identified as being located at a specific geographic location associated with a merchant; and
a processing device configured to
calculate at least one traffic metric for the consumer and the specific geographic location based on the time and/or date included in each of the received plurality of location data entries, and
associate, in a database, the consumer profile with the received plurality of location data entries and the calculated at least one traffic metric.

14. The system of claim 13, further comprising a transmitting device, wherein
the receiving device is further configured to receive a request for traffic metrics, wherein the request for traffic metrics includes an identifier associated with the consumer and the at least one traffic metric, and
the transmitting device is configured to transmit the calculated at least one traffic metric in response to the received request for traffic metrics.

15. The system of claim 14, wherein the request for traffic metrics further includes a predefined period of time, and wherein the time and/or date included in each of the plurality of location data entries is included within the predefined period of time.

16. The system of claim 13, wherein the at least one traffic metric includes at least one of: number of visits, average duration of visit, and average duration between visits.

17. The system of claim 13, wherein each location data entry further includes an indication of the mobile communication device as entering, remaining at, or leaving the specific geographic location.

18. The system of claim 13, wherein the associated mobile communication device is identified as being located at the specific geographic location using at least one of: global positioning system, cellular network triangulation, connection to a wireless network, reading of a machine-readable code located at the specific geographic location, and receiving of an aural signal emitted at the specific geographic location.

19. A system for measuring consumer traffic at a merchant location, comprising:
a database configured to store a plurality of consumer profiles, wherein each consumer profile includes data related to a consumer including at least a device identifier corresponding to a mobile communication device associated with the related consumer;
a receiving device configured to receive a plurality of location data entries, wherein each location data entry includes at least a device identifier and a time and/or date at which a mobile communication device associated with the included device identifier is identified as being located at a specific geographic location associated with a merchant; and
a processing device configured to
associate, in the database, each the received plurality of location data entries with a corresponding consumer profile based on the included device identifiers,
calculate at least one traffic metric for consumer traffic at the specific geographic location based on the time and/or date included in each of the plurality of location data entries associated with each consumer profile stored in the database, and
associate the calculated at least one traffic metric with the merchant.

20. The system of claim 19, further comprising a transmitting device, wherein
the receiving device is further configured to receive a request for traffic metrics, wherein the request for traffic metrics includes the at least one traffic metric and one of: the specific geographic location and the merchant, and
the transmitting device is configured to transmit the calculated at least one traffic metric in response to the received request for traffic metrics.

21. The system of claim 20, wherein the request for traffic metrics further includes a predefined period of time, and wherein the time and/or date included in each of the plurality of location data entries is included within the predefined period of time.

22. The system of claim 19, wherein the at least one traffic metric includes at least one of: number of new consumers, number of repeat consumers, total number of consumer visits, average number of consumer visits, number of unique consumers, average duration of consumer visits, and average duration between consumer visits.

23. The system of claim 19, wherein each location data entry further includes an indication of the associated mobile communication device as entering, remaining at, or leaving the specific geographic location.

24. The system of claim 19, wherein the respective mobile communication device associated with the device identifier included in each of the plurality of transaction data entries is identified as being located at the specific geographic location using at least one of: global positioning system, cellular network triangulation, connection to a wireless network, reading of a machine-readable code located at the specific geographic location, and receiving of an aural signal emitted at the specific geographic location.
